(19) United States
(12) Patent Application Publication
(10) Pub. No.: US 2011/0061824 A1
(43) Pub. Date: Mar. 17, 2011

(54) Erect Flexible Panel(s) with Support Member(s) and Connected Erect Flexible Panels Producing an Enclosure or Container

(76) Inventor: James W. Burrell, IV, Union, NJ (US)

(21) Appl. No.: 12/880,334

(22) Filed: Sep. 13, 2010

Related U.S. Application Data
(60) Provisional application No. 61/241,573, filed on Sep. 11, 2009.
(60) Provisional application No. 61/276,696.

(51) Int. Cl. F16S 1/00

(52) U.S. Cl. 160/378; 160/379; 160/381

(57) ABSTRACT

A panel of material enabled in an erect unfurled position using one or more diagonal support members attached at diagonal corners. Vertical and/or horizontal support members increase panel rigidity. Connecting at least three panels produces a collapsible upright flexible enclosure. Attaching a bottom panel produces a container. Attaching carrying straps to the top of the upright flexible container allows it to be carried and folded up. A panel can be attached to the top edges permanently or with some type of fastening means. The present invention can also be used as a housing structure. Placing a grommet in the middle of the roof and using a vertical pole to hold the roof up prevents roof sagging. Removing the roof's vertical support pole allows the roof to sag for rain water collection using a cistern in the middle of the enclosure. Support members can be removed for washing or folding.

### RELATED APPLICATION

This application is a continuation in part of U.S. Provisional Patent Application #61/241,573, filed Sep. 11, 2009 and titled: “Collapsible Upright Enclosure or Container”, and U.S. Provisional Patent Application #61/276,696, filed Jun. 09, 2010and titled: “Erect Flexible Panel(s) with Support Member(s) and Connected Erect Flexible Panels Producing an Enclosure or Container”.

### FIELD OF THE INVENTION

The present invention relates to a panel of flexible material supported in an unfurled and erect position using at least one or preferably two diagonal support members. Connecting at least three said erect flexible panels produces an enclosure or container. Adding vertical or horizontal support members increases the rigidity of each flexible panel.

### DESCRIPTION OF THE PRIOR ART

There are many prior art rigidly supported pieces of material which are well known. The most well known type is the type of kite flown by Benjamin Franklin when he discovered electricity. The kite design had a cross type internal light frame, with thin flexible material stretched over it and a tail attached to the bottom of the kite for stability. The kite's dimensions produced a quadrilateral figure having two pairs of equal adjacent sides, symmetrical only about the vertical diagonal. Another prior art supported piece of material is the externally supported boat sail; a piece of material held vertically on a mast and attached horizontally to a top point or linear edge and a bottom linear edge. The sail's dimensions have been triangular, square or rectangular. Anther supported piece of material includes the wind-catching sails attached to the arms of a windmill.

None of the prior art solutions for supporting a piece of material use the same means and methods for supporting a piece of material in an unfurled position using at least one or two diagonal support members disclosed in this patent application. The addition of vertical and/or horizontal support members increase the rigidity of each panel. The description of the present invention makes it non-obvious over all prior art.

### OBJECTS OF THE INVENTION

It is an object of the present invention to provide a means and method for supporting at least one flexible panel of material in an unfurled position using only one diagonal support member.

It is another object of the present invention to provide a means and method for supporting at least one flexible panel of material in an unfurled position using two diagonal support members. Adding vertical or horizontal support members increases the rigidity of each flexible panel of material.

It is yet another object of the present invention to provide a means and method for supporting flexible panels of material in an unfurled position using preferably two diagonal support members and connecting at least three rigidly supported panels of material to produce an enclosure or container. Adding vertical or horizontal support members increases the rigidity of each flexible panel of material.

These and other objects and advantages of the present invention are provided within this patent application.

### SUMMARY OF THE INVENTION

In order to accomplish the objects of the present invention, the means and method for supporting a panel of material in an unfurled position using one or two diagonal support members produces an erect unfurled flexible panel or connected erect flexible panels producing an enclosure or container.

In one embodiment of the present invention, a flexible panel of material is supported in an unfurled position using one diagonal support member, where one end is attached to a bottom corner on a vertically supported edge and the opposite end is attached to a top corner. Alternatively, a second diagonal support member can be attached on the opposite side of the flexible panel of material sandwiching the flexible panel of material in between the first diagonal support member and second diagonal support member.

In another embodiment of the present invention, a flexible panel of material is supported in an unfurled position using two diagonal support members; where a first diagonal support member end is attached to a bottom corner on a vertically supported edge and the opposite end is attached to a top corner on a non-vertically supported edge and a second diagonal support member end is attached to a top corner on a vertically supported edge and the opposite end is attached to a bottom corner on a non-vertically supported edge. The flexible panel of material is preferably sandwiched between a first diagonal support member and a second diagonal support member. At the point where the middles of the first diagonal support member and the second diagonal support member intersect, they are preferably fastened together.

In another embodiment of the present invention, a flexible panel of material is held in an unfurled position using a first diagonal support member attached to diagonal corners and a second diagonal support member attached to diagonal corners. For increasing the vertical rigidity of the flexible panel of material, the flexible panel of material is also vertically reinforced with middle, left and right vertical support members attached to horizontal edges.

In another embodiment of the present invention, a flexible panel of material is held in an unfurled position using a first diagonal support member attached to diagonal corners and a second diagonal support member attached to diagonal corners. For increasing the vertical rigidity of the flexible panel of material, the flexible panel of material is also vertically reinforced with middle, left and right vertical support members attached to horizontal edges. For increasing the horizontal rigidity of the flexible panel of material, the flexible panel of material is also horizontally reinforced with middle, top and bottom horizontal support members attached to vertical edges.

In another embodiment of the present invention, an assembled and erect collapsible upright flexible enclosure or container, with at least three sides, where each side is held upright and in an unfurled position using two preferably diagonal support members on each panel side.

Carrying straps attached to the top opposite sides of the four sided collapsible upright flexible enclosure or container allows it to be carried and folded up and compactly secured using the carrying straps as a securing and carrying closure means by wrapping the top carrying straps around the bottom of the eight diagonal support members.

In another embodiment of the present invention, an assembled and erect collapsible upright flexible enclosure or container, with four sides, where two opposite sides are held upright and in an unfurled position using two preferably diagonal support members on each opposite panel sides and the other two opposite sides are held in an unfurled position using a top horizontal support member and a bottom horizontal support member instead of two diagonal support members.

The preferred means and method of securing the support members include using receiving pockets, grommets and fasteners, locking insertion pins, magnetic type fasteners, etc. receiving pockets, grommets and fasteners, locking insertion pins, magnetic type fasteners, etc.

Securing a piece of loop tape (Velcro™) to the middle of each side panel section where the flexible diagonal support members and intersect, allows a piece of hook tape (Velcro™) to be placed over the flexible diagonal support members and intersection point and secured to the piece of loop tape (Velcro™) or vice versa.

Another embodiment of the present invention would also include flexible vertical support members inserted into vertical top and bottom support member securing means on each corner or in the middle of the collapsible upright flexible enclosure or container to increase vertical stability.

Another embodiment of the present invention would also include flexible horizontal support members inserted into horizontal top and bottom support member securing means on each horizontal top edge and on each horizontal bottom edge or in the middle of the collapsible upright flexible enclosure or container to increase horizontal stability.

Another embodiment of the present invention would use a top panel section attached to the top edges of the collapsible upright flexible enclosure or container. The top panel section can be attached to all sides of the top edges permanently or can be made to be removed or be made to open with one side of the top panel section permanently attached to one side of the top edges of the collapsible upright flexible enclosure or container and preferably a fastening means on the opposite top edge.

Another embodiment of the present invention could be used as a temporary housing structure for emergency and disaster use. By placing a grommet in the middle of the roof, a vertical pole can be used to hold the roof up and prevent sagging of the roof. By removing the roof's vertical pole support and allowing the roof to sag downward, the roof can also be used as a means of water collection, where the rain water is collected and stored in a cistern (55 gallon drum, etc.) in the middle of the enclosure.

A multitude of modifications and enhancements can be made to the flexible panel of material supported in an unfurled position using one or preferably two diagonal support members and connecting at least three of said panels, but preferably four of said panels, produces an enclosure or container without departing from the spirit and scope of the invention as a whole.

These and other objects, features and advantages of the present invention will be better understood in connection with the following drawings and descriptions of the preferred embodiments.

### DESCRIPTION OF THE DRAWINGS

For a better understanding of the invention as well as other objects, features and advantages thereof, reference is made to the following detailed description to be read in conjunction with the accompanying drawings, wherein:

FIG. 1 is a side perspective view of a flexible panel of material supported in an unfurled position using one diagonal support member where one end is attached to a bottom, preferably reinforced, corner on a vertically supported edge using a preferred grommet fastening means and the opposite end is attached to a top, preferably reinforced, corner on a non-vertically supported edge using a preferred grommet fastening means. The flexible panel of material is preferably a flag.

FIG. 2 is a side perspective view of a flexible panel of material supported in an unfurled position using two diagonal support members; where a first diagonal support member end is attached to a bottom, preferably reinforced, corner on a vertically supported edge using a preferred grommet fastening means and the opposite end is attached to a top, preferably reinforced, corner on a non-vertically supported edge using a preferred grommet fastening means and a second diagonal support member end is attached to a top, preferably reinforced, corner on a vertically supported edge using a preferred grommet fastening means and the opposite end is attached to a bottom, preferably reinforced, corner on a non-vertically supported edge using a preferred grommet fastening means. The flexible panel of material is preferably sandwiched between a first diagonal support member and a second diagonal support member. At the point where the middles of the first diagonal support member and the second diagonal support member intersect, they are fastened together using a preferred grommet fastening means, sandwiching the flexible panel of material between the middles of the first diagonal support member and the second diagonal support member. The flexible panel of material is preferably a flag.

FIG. 3 is a side perspective view of a flexible panel of material held in an unfurled position using a first diagonal support member and a second diagonal support member attached to diagonal corners using receiving pocket fastening means for inserting the preferably rounded ends of each diagonal support member. For increasing the vertical rigidity of the flexible panel of material, the flexible panel of material is also vertically reinforced with middle, left and right vertical support members attached to horizontal edges using vertical receiving pocket fastening means for inserting the preferably rounded ends of each vertical support member.

FIG. 4 is a perspective view of a flexible panel of material held in an unfurled position using a first diagonal support member and a second diagonal support member attached to diagonal corners using receiving pocket fastening means for inserting the preferably rounded ends of each diagonal support member. For increasing the vertical rigidity of the flexible panel of material, the flexible panel of material is also vertically reinforced with middle, left and right vertical support members attached to horizontal edges using vertical receiving pocket fastening means for inserting the preferably rounded ends of each vertical support member. For increasing the horizontal rigidity of the flexible panel of material, the flexible panel of material is also horizontally reinforced with middle, top and bottom horizontal support members attached to vertical edges using horizontal receiving pocket fastening means for inserting the preferably rounded ends of each horizontal support member.

FIG. 5 is a perspective view of an assembled and erect four sided collapsible upright flexible enclosure or container, where each side is held upright and in an unfurled position using two preferably external diagonal support members on each panel side. The diagonal support members shown on the outside of the enclosure/container but can also be located on the inside of the enclosure or container.

FIG. 6 is a frontal perspective view of the assembled and erect four sided collapsible upright flexible enclosure or container shown in FIG. 5 where carrying straps have been attached to the top opposite sides of the four sided collapsible upright flexible enclosure or container and the four sided collapsible upright flexible enclosure or container has been folded up and compactly secured using the carrying straps as a securing and carrying closure means by wrapping the top carrying straps around the bottom of the eight diagonal support members.

FIG. 7 is a perspective view of the assembled and erect four sided collapsible upright flexible enclosure or container shown in FIG. 5 where two opposite panel sides of the erect four sided collapsible upright flexible enclosure or container both use a top and bottom horizontal support member instead of two diagonal support members.

### LIST OF REFERENCE NUMBERING

1 shows a flexible panel of some type of material in an unfurled position using at least one or preferably two diagonal support members.
2 shows a first diagonal support member end fastened to a bottom, preferably reinforced, corner on a vertically supported edge and an opposite first diagonal support member end fastened to a top, preferably reinforced, diagonal corner.
3 shows a shows a second diagonal support member end, preferably located on an opposite side of a flexible panel, fastened to a top, preferably reinforced, corner on a vertically supported edge and an opposite second diagonal support member end fastened to a bottom, preferably reinforced, diagonal corner.
4 shows a vertically supported reinforced edge of a flexible panel.
5 shows a top, preferably reinforced, corner on a vertically supported edge of a flexible panel and a fastening point or means.
6 shows a bottom, preferably reinforced, corner on a vertically supported edge of a flexible panel and a fastening point or means.
7 shows a top, preferably reinforced, corner on a non-vertically supported edge of a flexible panel and a fastening point or means.
8 shows a bottom, preferably reinforced, corner on a non-vertically supported edge of a flexible panel and a fastening point or means.
9 shows a fastening point centrally located in the vertical and horizontal middle location of a flexible panel for fastening the flexible panel in between the middles of a first diagonal support member and a second diagonal support member.
10 shows a panel section using panel of flexible material.
15 shows an inside edge of a panel section using panel of flexible material.
20 shows an inside bottom corner securing point of a panel section.
25 shows an outside top corner securing point of a panel section.
30 shows a first diagonal support member.
40 shows a securing means.
50 shows an inside top corner securing point of a panel section.
55 shows an outside bottom corner securing point of a panel section.
60 shows a second diagonal support member.
70 shows a central point of a panel section where a first and a second diagonal support member intersect.
80 shows a top horizontal support member.
85 shows a bottom horizontal support member. p0 102 shows a first diagonal support member.
103 shows a second diagonal support member.
104 shows a middle vertical support member.
105 shows a left vertical support member.
106 shows a right vertical support member.
107 shows a middle horizontal support member.
108 shows a top horizontal support member.
109 shows a bottom horizontal support member.
110 shows a diagonal top left corner fastening point or securing means.
111 shows a diagonal top right corner fastening point or securing means.
112 shows a diagonal bottom left corner fastening point or securing means.
113 shows a diagonal bottom right corner fastening point or securing means.

### DETAILED DESCRIPTION OF THE PREFERRED EMBODIMENTS

The following detailed description is of the best presently contemplated modes of carrying out the invention. This description is not to be taken in a limited sense, but is made merely for the purpose of illustrating general principles of embodiments of the invention. The scope of the invention is best defined by the description found in the present patent application, the drawings and the appended claims.

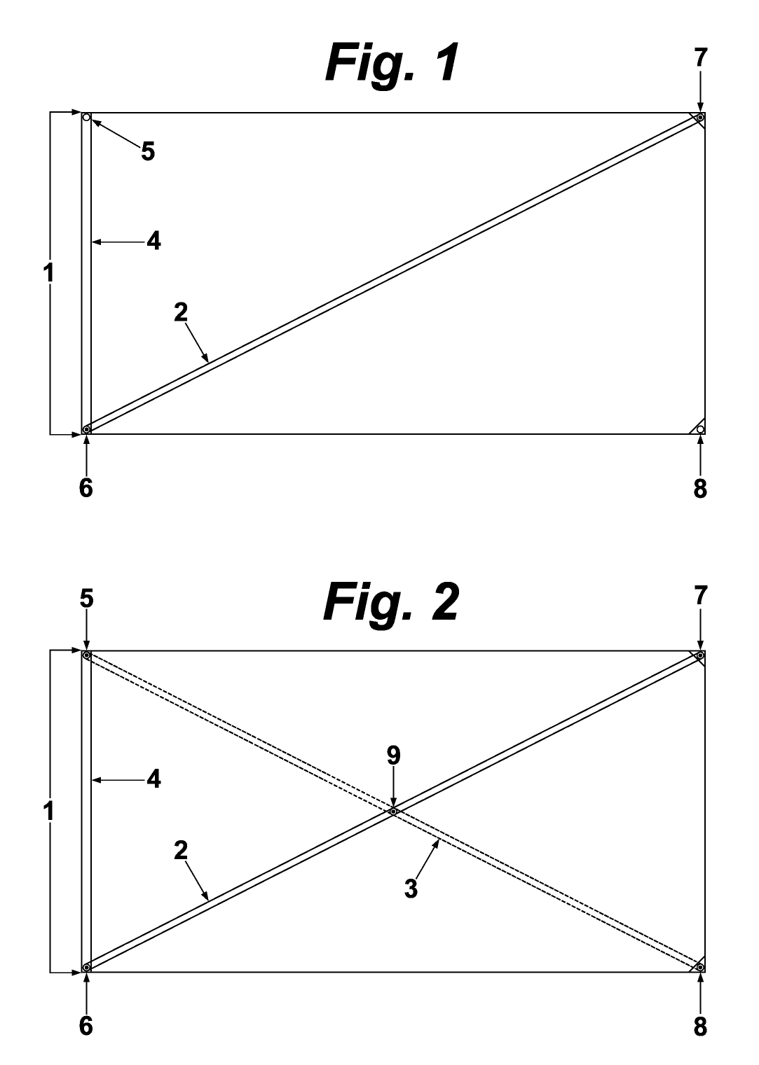

As shown in FIGS. 1 and 2, the basic component for the a flexible panel of material 1 supported in an unfurled position comprises one diagonal support member 2 or preferably two diagonal support members 2 and 3 in a diagonal arrangement or a sandwiching arrangement for maintaining a unfurled position. Also explained in greater detail in this patent application, at least three flexible panels of material 1 supported in an unfurled position using two diagonal support members 2 and 3 for maintaining a unfurled position, according to the present invention, are all preferably connected together to create an enclosure or container 10.

According to the present invention, the foregoing and other objects and advantages are attained by providing a flexible panel of material 1 supported in an unfurled position, wherein the unfurled inside edge 4 is secured to a rope, pole, etc. from an inside top corner securing point 5 and an inside bottom corner securing point 6. When the unfurled inside edge 4 of the flexible panel of material 1 is vertically secured to a rope, pole, etc., the flexible panel of material 1 will drape down, supported from the inside top corner securing point 5, where the outside bottom corner securing point 8 will be closest to the ground. One preferred embodiment entails attaching one end of a diagonal support member 2 to an inside bottom corner securing point 6 using a securing means and attaching the other end of a diagonal support member 2 to an outside top corner securing point 7 using a securing means. The securing means can be in the form of a receiving pocket, a grommet, or any other type of fastening or securing means.

The diagonal support members 2 and 3 are preferably transparent or translucent. If the diagonal support members 2 and 3 are being secured to the flexible panel of material 1 where both ends are inserted into opposite diagonal corner receiving pockets, the diagonal support members 2 and 3 are preferably made out of a flexible material. If the diagonal support members 2 and 3 are being secured to the flexible panel of material 1 where both ends are inserted into opposite corner grommets, the diagonal support members 2 and 3 are preferably made out of a flexible material. If the diagonal support members 2 and 3 are being secured to the flexible panel of material 1 where both ends are attached to opposite corner grommets, the diagonal support members 2 and 3 can be made out of a rigid material. A good transparent/translucent material for the diagonal support members 2 and 3 would be a plexiglass or Lexan™ material. To prevent wear of the flexible panel of material 1 from wind and movement, the diagonal support member's 2 and 3 or one or two diagonal support member's 2 ends should be rounded and the edges coming in contact with the flexible panel of material 1 should be rounded. Rounding of the diagonal support member's edges 2 or 3 coming in contact with the flexible panel of material 1 can be done with a router or be one of the dimensions molded into the part. The corner securing points on the flexible panel of material 1 should also have some type of reinforcement included. Additional securing/fastening points in the middle of or along the diagonal support members 2 and 3 or in the middle of or along one or two diagonal support member(s) 2 are also provided to increase reinforcement and to prevent wear and tear of the flexible panel of material 1 from wind and movement.

Referring to FIG. 1, according to a first preferred embodiment of the present invention, FIG. 1 illustrates a flexible panel of material 1 supported in an unfurled position using one diagonal support member 2 where one end is attached to a bottom, preferably reinforced, corner 6 on a vertically supported edge 4 using a preferred grommet fastening means and the opposite end is attached to a top, preferably reinforced, corner 7 on a non-vertically supported edge using a preferred grommet fastening means. The flexible panel of material 1 is preferably a flag.

Alternatively, a second diagonal support member 2 can be attached on the opposite side of the flexible panel of material 1 sandwiching the flexible panel of material 1 in between the first diagonal support member 2 and second diagonal support member 2 increasing the rigidity of the diagonal support members 2 for extra large flexible panels of material 1 (flags and banners). Additional securing means (grommets) can also be used to sandwich the flexible panel of material 1 in between the diagonal support members 2 to increase the rigidity of the diagonal support members 2.

FIG. 2 illustrates a flexible panel of material 1 supported in an unfurled position using two diagonal support members; where a first diagonal support member 2 end is attached to a bottom, preferably reinforced, corner 6 on a vertically supported edge 4 using a preferred grommet fastening means and the opposite end is attached to a top, preferably reinforced, corner 7 on a non-vertically supported edge using a preferred grommet fastening means and a second diagonal support member 3 end is attached to a top, preferably reinforced, corner 5 on a vertically supported edge 4 using a preferred grommet fastening means and the opposite end is attached to a bottom, preferably reinforced, corner 8 on a non-vertically supported edge using a preferred grommet fastening means. The flexible panel of material 1 is preferably sandwiched between a first diagonal support member 2 and a second diagonal support member 3. At the point where the middles of the first diagonal support member 2 and the second diagonal support member 3 intersect 9, they are fastened together using a preferred grommet fastening means, sandwiching the flexible panel of material 1 between the middles of the first diagonal support member 2 and the second diagonal support member 3. The flexible panel of material is preferably a flag.

One preferred method of attaching the erect panel of flexible material (flag) of FIG. 1 or FIG. 2 onto a flagpole would be using two circular metal loops (carabiner/karabiner) with spring or screwed gates, and both circular metal loops having an inside diameter larger than the outside diameter of a flag pole, and attaching the two circular metal loops to both attaching means on the flagpole's hoisting rope. Another method of attaching the erect panel of flexible material (flag) of FIG. 1 or FIG. 2 onto a flagpole would be using two loosely fitted plastic tie wraps.

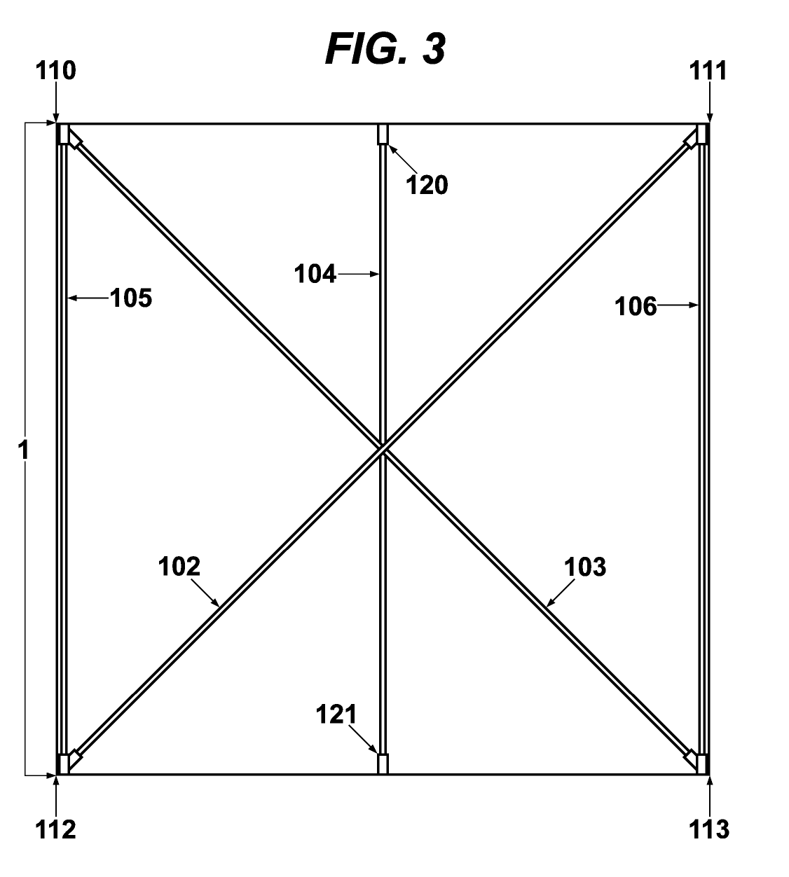

FIG. 3 illustrates a flexible panel of material 1 held in an unfurled position using a first diagonal support member 102 attached to diagonal corners 111 and 112 and a second diagonal support member 103 attached to diagonal corners 110 and 113 using receiving pocket fastening means for inserting the preferably rounded ends of each diagonal support member 102 and 103. For increasing the vertical rigidity of the flexible panel of material 1, the flexible panel of material 1 is also vertically reinforced with middle 104, left 105 and right 106 vertical support members attached to horizontal edges using vertical receiving pocket fastening means 120 and 121, 110 and 112, and 111 and 113 for inserting the preferably rounded ends of each vertical support member 104, 105 and 106.

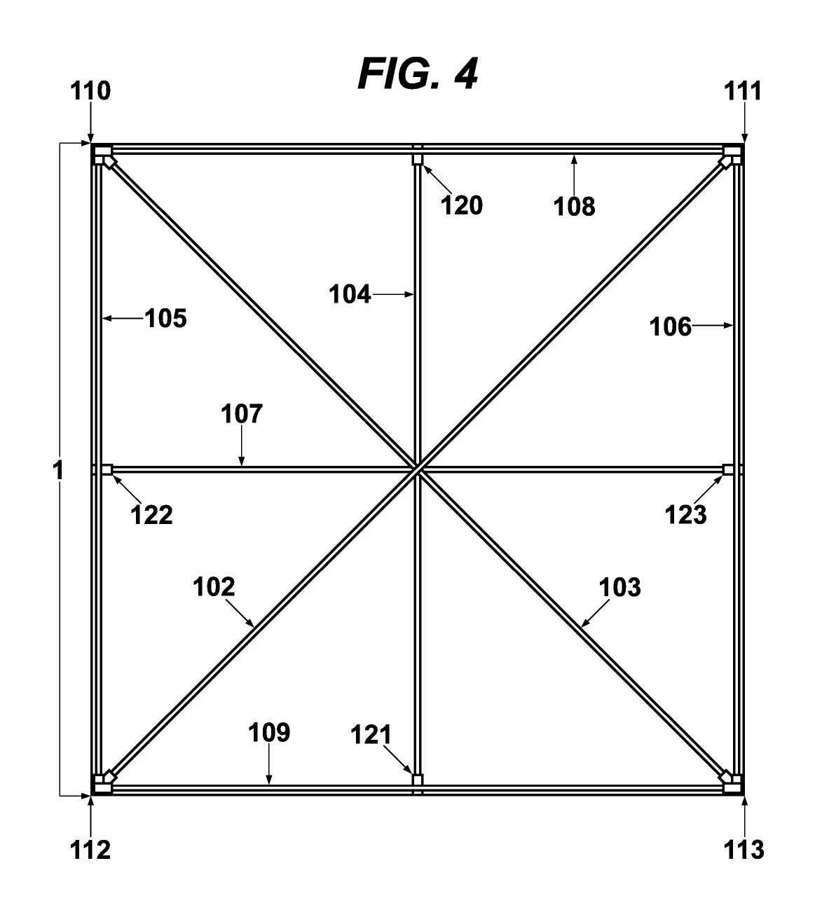

FIG. 4 illustrates a flexible panel of material 1 held in an unfurled position using a first diagonal support member 102 attached to diagonal corners 111 and 112 and a second diagonal support member 103 attached to diagonal corners 110 and 113 using receiving pocket fastening means for inserting the preferably rounded ends of each diagonal support member 102 and 103. For increasing the vertical rigidity of the flexible panel of material 1, the flexible panel of material 1 is also vertically reinforced with middle 104, left 105 and right 106 vertical support members attached to horizontal edges using vertical receiving pocket fastening means 120 and 121, 110 and 112, and 111 and 113 for inserting the preferably rounded ends of each vertical support member 104, 105 and 106. For increasing the horizontal rigidity of the flexible panel of material 1, the flexible panel of material 1 is also horizontally reinforced with middle 107, top 108 and bottom 109 horizontal support members attached to vertical edges using horizontal receiving pocket fastening means 122 and 123, 110 and 111, and 112 and 113 for inserting the preferably rounded ends of each horizontal support member 107, 108 and 109.

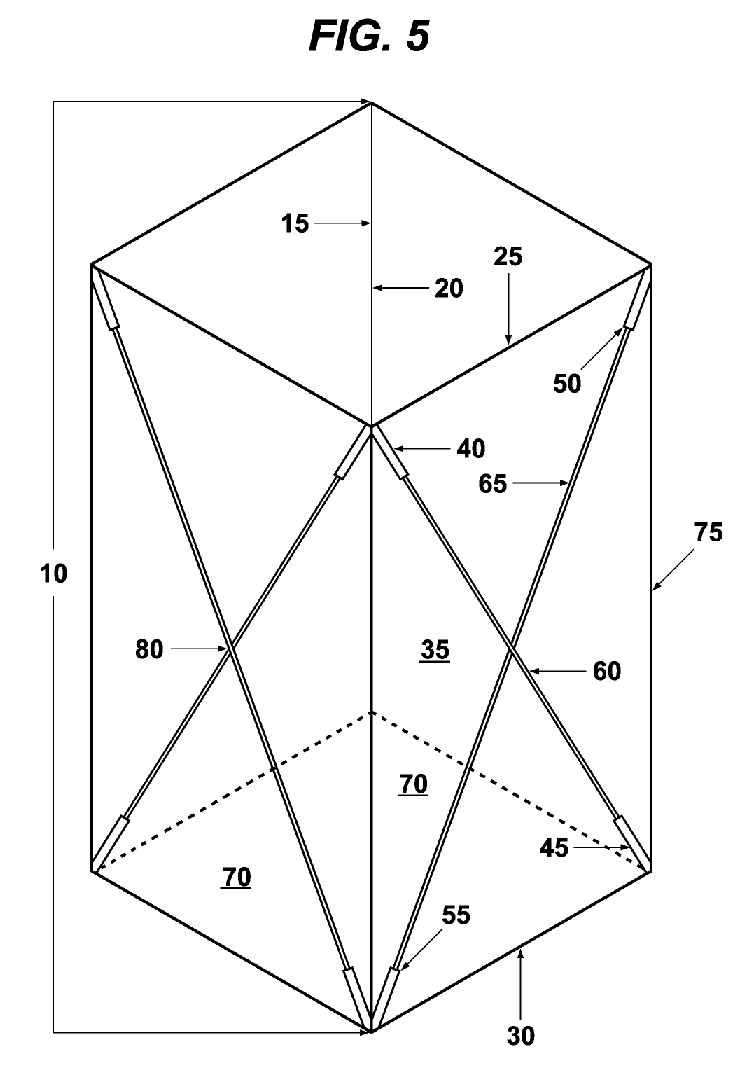

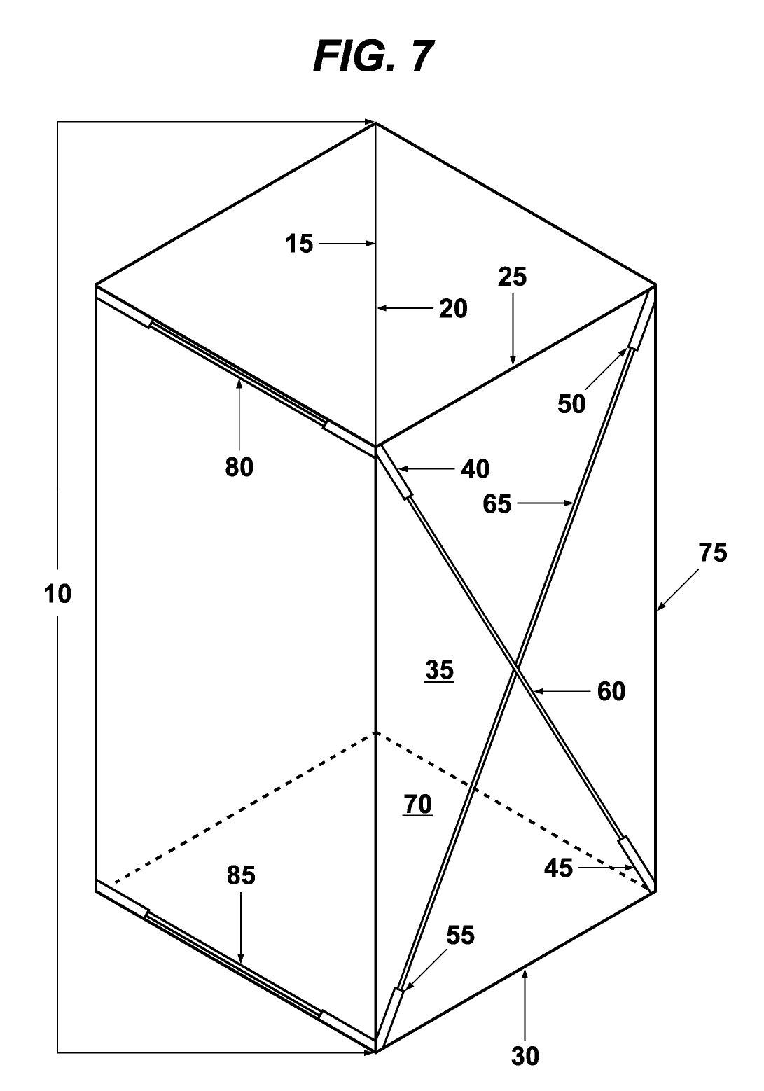

As shown in FIGS. 5 and 7, the basic component for the vertically standing and collapsible upright flexible enclosure's or container's 10 side panel 35 is supported by two diagonal flexible support members 60 and 65 secured to two opposite top 40 and 50 and two bottom corners 45 and 55 diagonal support member securing means. In order to more fully understand the present invention, during the course of this description, the vertically standing collapsible upright flexible enclosure or container 10 and preferred embodiments, will be labeled and explained to easily identify like elements according to the different embodiments which illustrate the presently disclosed invention. The scope of the invention is best defined by the appended claims and the description provided herein. Additional objects of the present invention will become apparent as the description proceeds.

FIG. 5 illustrates an assembled and erect four sided collapsible upright flexible enclosure or container 10, where each side 35 is held upright and in an unfurled position using two preferably external diagonal support members 60 and 65 on each panel side 35. The diagonal support members 60 and 65 shown on the outside of the enclosure/container 10, but can also be located on the inside or on the inside and outside of the enclosure or container 10.

The invention disclosed in the present patent application preferably uses at least one sheet of flexible material 35 connected at a first left end 15 and a second right end 20, using some type of attaching method (receiving pockets, grommets and fasteners, locking insertion pins, magnetic type fasteners, etc.), to create an at least three sided hollow shape for producing an enclosure or container 10 with the desired amount of sides. If each flexible material panel 35 is constructed separately, then each panel must be attached to each other after assembly to produce the enclosure or a container 10. In the case of using only one sheet of flexible material panel 35, before attaching the first left end 15 and second right end 20 of the enclosure, the following steps are required in the assembly process. The top edge 25 of the sheet of flexible material should be reinforced. The top edge 25 can either be bound, a reinforcing panel of material can be attached to the top edge 25 or the top edge 25 can be folded in upon itself once or twice and secured in place using some type of securing method. If the invention is to be used as an enclosure, then the same process should be performed on the bottom edge 30. The two top corners 40 and 50 diagonal support member securing means and two bottom corners 45 and 55 diagonal support member securing means have to be attached to the four corners of each side panel section 35. After the two top corners 40 and 50 diagonal support member securing means and two bottom corners 45 and 55 diagonal support member securing means have to be attached to the four corners of each side panel, the first left end 15 and second right end 20 of the enclosure 10 are attached. If the enclosure 10 is going to be used as a container 10, a bottom panel section 70 has to be attached to the bottom edge 30 of the enclosure 10.

To finish the steps of producing a vertically standing and collapsible upright flexible enclosure or container 10 with two diagonal support members 60 and 65 for each side, one end of the first flexible diagonal support member 60 has to be inserted into the top left corner diagonal support member securing means 40 and the opposite end of the first flexible diagonal support member 60 has to be inserted into the bottom right corner diagonal support member securing means 45 of a side panel section 35, and then one end of the second flexible diagonal support member 65 has to be inserted into the top right corner diagonal support member securing means 50 and the opposite end of the second flexible diagonal support member 65 has to be inserted into the bottom left corner diagonal support member securing means 55 of the side panel section 35. Completing this assembly process on each side panel section 35 produces the fully functional vertically standing collapsible upright flexible enclosure or container. The preferred dimensions of a laundry bag container would preferably be two feet wide, two feet deep and three feet high. Although it is not shown in FIGS. 5 and 7, the addition of two extra long carrying straps attached to opposite sides of the top edges 25 allow the laundry bag container to be carried as a backpack and to secure the container in a fully collapsed position for carrying by the straps like a purse.

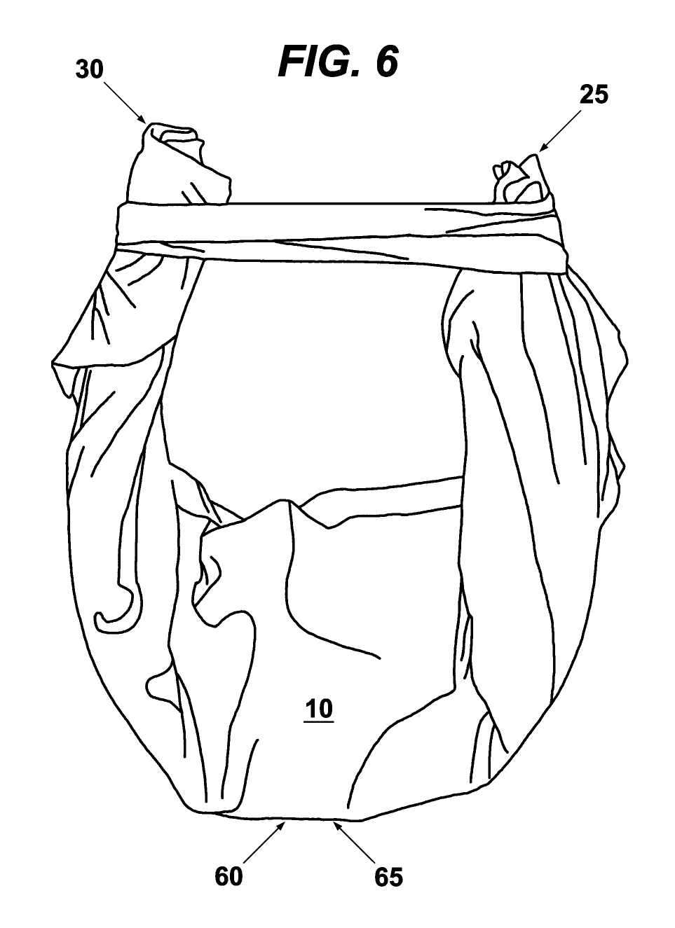

FIG. 6 illustrates the assembled and erect four sided collapsible upright flexible enclosure or container 10 shown in FIG. 5 where the previously disclosed carrying straps have been attached to the top opposite sides 25 of the four sided collapsible upright flexible enclosure or container 10 and the four sided collapsible upright flexible enclosure or container 10 has been folded up and compactly secured using the carrying straps as a securing and carrying closure means by wrapping the top carrying straps around the bottom 30 of the eight diagonal support members 60 and 65.

FIG. 7 illustrates the assembled and erect four sided collapsible upright flexible enclosure or container 10 shown in FIG. 5 where two opposite panel sides of the erect four sided collapsible upright flexible enclosure or container 10 both use a top horizontal support member 80 and a bottom horizontal support member 85 instead of two diagonal support members 60 and 65 for both opposite parallel sides.

Securing a piece of loop tape (Velcro™) to the middle 80 of each side panel section 35 where the flexible diagonal support members 60 and 65 intersect, allows a piece of hook tape (Velcro™) to be placed over the flexible diagonal support members 60 and 65 intersection point 80 and secured to the piece of loop tape (Velcro™) or vice versa.

Another embodiment of the present invention, shown in FIG. 3, would also include flexible vertical support members inserted into vertical top 25 and bottom 30 support member securing means on each corner 75 of the collapsible upright flexible enclosure or container 10 to increase vertical stability. Another means of increasing vertical stability for larger enclosures or containers, includes flexible vertical support members inserted into top 25 and bottom 30 support member securing means in the middle of each side panel section 35, where each flexible vertical support member intersects with the flexible diagonal support members 60 and 65 at their intersection point 80.

Another embodiment of the present invention, shown in FIG. 4, would also include flexible horizontal support members inserted into horizontal top 25 and bottom 30 support member securing means on each horizontal top edge 25 and on each horizontal bottom edge 30 of the collapsible upright flexible enclosure or container 10 to increase horizontal stability. Another means of increasing horizontal stability for larger enclosures or containers, includes flexible horizontal support members inserted into horizontal support member securing means in the middle of each side panel section 35, where each flexible horizontal support member intersects with the flexible diagonal support members 60 and 65 at their intersection point 80.

Another embodiment of the present invention would use a top panel section attached to the top edges 25 of the collapsible upright flexible enclosure or container 10. The top panel section can be attached to all sides of the top edges 25 permanently or can be made to be removed or be made to open with one side of the top panel section permanently attached to one side of the top edges 25 of the collapsible upright flexible enclosure or container 10 and preferably a fastening means on the opposite top edge 25.

Another embodiment of the present invention could be used as a temporary housing structure for emergency and disaster use. By placing a grommet in the middle of the roof, a vertical pole can be used to hold the roof up and prevent sagging of the roof. By removing the roof's vertical pole support and allowing the roof to sag downward, the roof can also be used as a means of water collection, where the rain water is collected and stored in a cistern (55 gallon drum, etc.) in the middle of the enclosure.

These and other features of the present invention will be more fully understood by referencing the drawings. While the preceding description refers to particular embodiments of the present invention, it will be understood that many modifications may be made without departing from the spirit and scope of the invention.

### ADVANTAGES OF THE PRESENT INVENTION

In summary, the present invention, previously described, has provided at least one panel of material supported in an unfurled position using one or preferably two attached diagonal support members to maintain said unfurled position. Adding vertical or horizontal support members increases the rigidity of the unfurled panel of material. The present invention will most likely be used to unfurl flags, banners and the like for full panel display at places like the United Nations, Olympic Games, sporting events, government and public buildings, flag poles, etc. Using at least three connected erect flexible panels also produces an enclosure or container where each panel maintains an unfurled position. Adding vertical and/or horizontal support members increases the rigidity of each unfurled panel of material.

While the present invention disclosed has been described with reference to the preferred embodiments thereof, a latitude of modification, change, and substitution is intended in the foregoing disclosure, and in some instances, some features of the invention will be employed without a corresponding use of the invention's other features. Accordingly, it will be appreciated by those having an ordinary skill in the art that various modifications can be made to the system of the invention and it is appropriate that the description and appended claims are construed broadly and in a manner consistent with the spirit and scope of the invention herein without departing from the spirit and scope of the invention as a whole. The accompanying claims are intended to cover such modifications as would fall within the true scope and spirit of the present invention.

1. A flexible panel of material supported in an unfurled position comprising:
a first end of a diagonal support member attached to a bottom inside corner on a vertically supported edge on said flexible panel of material; and
a second opposite end of said diagonal support member attached to a diagonal top outside corner on said flexible panel of material.

2. The flexible panel of material supported in an unfurled position of claim 1, further comprising attaching said diagonal support member to said flexible panel of material with at least one attaching point in between said first end and said second opposite end of said attached diagonal support member.

3. The flexible panel of material supported in an unfurled position of claim 1, further comprising a second diagonal support member attached on an opposite side of said flexible panel of material sandwiching said flexible panel of material in between said first attached diagonal support member and said second attached diagonal support member.

4. The flexible panel of material supported in an unfurled position of claim 3, further comprising attaching said first and said second diagonal support members to said sandwiched flexible panel of material with at least one attaching point in between said first ends and said second opposite ends of said first and said second attached diagonal support members.

5. The flexible panel of material supported in an unfurled position of claim 1, further comprising a second diagonal support member attached to said flexible panel of material wherein:
a first end of said second diagonal support member attached to a top inside corner on a vertically supported edge on said flexible panel of material; and
a second opposite end of said second diagonal support member attached to a diagonal bottom outside corner on said flexible panel of material.

6. The flexible panel of material supported in an unfurled position of claim 5, further comprising attaching said first and said second diagonal support members to said flexible panel of material where said first and said second diagonal support members intersect.

7. The flexible panel of material supported in an unfurled position of claim 5, further comprising attaching said first and said second diagonal support members to said flexible panel of material where said first and said second diagonal support members intersect and sandwich said flexible panel of material.

8. The flexible panel of material supported in an unfurled position of claim 1, wherein said diagonal support member's ends are rounded to prevent damage to said flexible panel of material.

9. The flexible panel of material supported in an unfurled position of claim 1, wherein said diagonal support member's edges are rounded to prevent damage to said flexible panel of material.

10. The flexible panel of material supported in an unfurled position of claim 1, further comprising attaching at least one vertical support member to said flexible panel of material for increasing vertical rigidity.

11. The flexible panel of material supported in an unfurled position of claim 1, further comprising attaching at least one horizontal support member to said flexible panel of material for increasing horizontal rigidity.

12. A flexible panel of material supported in an unfurled position comprising:
a first end of a first diagonal support member attached to a bottom inside corner on a vertically supported edge on said flexible panel of material; and
a second opposite end of said first diagonal support member attached to a diagonal top outside corner on said flexible panel of material; and
a first end of a second diagonal support member attached to a bottom inside corner on a vertically supported edge on an opposite side of said flexible panel of material; and
a second opposite end of said second diagonal support member attached to a diagonal top outside corner on an opposite side of said flexible panel of material; and
said flexible panel of material is sandwiched in between said first attached diagonal support member and said second attached diagonal support member.

13. The flexible panel of material supported in an unfurled position of claim 12, further comprising attaching said first attached diagonal support member and said second attached diagonal support member to said flexible panel of material with at least one attaching point in between said first ends and said second opposite ends of said first attached diagonal support member and said second attached diagonal support member.

14. A vertically standing collapsible enclosure with at least three connected flexible panels of material supported in an unfurled position wherein:
each said flexible panel of material is supported in an unfurled position using a first end of a first diagonal support member secured to a top left corner and a second opposite end of said first diagonal support member secured to a bottom right corner; and
each said flexible panel of material is also supported in an unfurled position using a first end of a second diagonal support member secured to a top right corner and a second opposite end of said second diagonal support member secured to a bottom left corner.

15. The vertically standing collapsible enclosure with at least three connected flexible panels of material supported in an unfurled position of claim 14, further comprising a means of attaching said first and said second diagonal support member's intersection point to the middle of each said flexible panels of material.

16. The vertically standing collapsible enclosure with at least three connected flexible panels of material supported in an unfurled position of claim 14, further comprising a means of increasing vertical rigidity using at least one vertical support member where a first end of said vertical support member is secured to a top edge and a second end of said vertical support member is secured to a bottom edge.

17. The vertically standing collapsible enclosure with at least three connected flexible panels of material supported in an unfurled position of claim 14, further comprising a means of increasing horizontal rigidity using at least one horizontal support member where a first end of said horizontal support member is secured to a left edge and a second end of said horizontal support member is secured to a right edge.

18. The vertically standing collapsible enclosure with at least three connected flexible panels of material supported in an unfurled position of claim 14, further comprising a bottom panel attached to each bottom edge on each of said flexible panel of material.

19. The vertically standing collapsible enclosure with at least three connected flexible panels of material supported in an unfurled position of claim 14, further comprising a top panel attached to each bottom edge on each of said flexible panel of material.

20. The vertically standing collapsible enclosure with at least three connected flexible panels of material supported in an unfurled position of claim 14, further comprising at least one carrying strap attached to a top edge on one of said flexible panel of material.
